(19) United States
(12) Patent Application Publication
(10) Pub. No.: US 2005/0231637 A1
(43) Pub. Date: Oct. 20, 2005

(54) Method for live image display and apparatus for performing the same

(76) Inventors: Eric Jeffrey, Richmond (CA); Phil Van Dyke, Surrey (CA); George Lyons, Langley (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/826,488

(22) Filed: Apr. 16, 2004

(51) Int. Cl. H04N 7/01; H04N 9/64; H04N 5/445

(52) U.S. Cl. 348/445; 348/563; 348/571

(57) ABSTRACT

A method and associated apparatus is provided for displaying a live image in a display window without corruption or loss of image data. More specifically, the method and associated apparatus maintain consistency between a size of an image to be displayed and a size of a display window in which the image is to be displayed. The method requires implementation of dimension value changes associated with the image to be displayed and the display window to be delayed until all required dimension value changes have been stored in a memory. Upon completion of storing each required dimension value change in the memory, a size change completion signal is provided by setting an enable bit within the memory. Upon receipt of a trigger signal while the enable bit is set, the dimension value changes associated with the image to be displayed and the display window are implemented together.

### BACKGROUND OF THE INVENTION

1. Field of the Invention

The present invention relates generally to display of digital image data.

2. Description of the Related Art

Some modern display devices are equipped with an ability to display a camera image within a specified area, i.e., display window, of a main display image. Often, a size difference exists between the camera image, as received by the display device, and the corresponding display window. If the sizes of the received camera image and the display window are not equal upon display of the camera image, the camera image will not display properly. Therefore, it is often necessary for the received camera image to be resized to match the display window size.

Typically, the camera image and the corresponding display window are represented as rectangular areas defined within a Cartesian coordinate system. Coordinate values defining the camera image and display window rectangular areas are commonly stored in a memory. Thus, when the display window size is changed and/or the received camera image size is changed to match the display window size, the associated coordinate values stored in the memory are changed.

Often, the coordinate values stored in the memory for defining the camera image and the display window sizes are implemented, i.e., made effective, promptly upon being changed. Since required changes to the coordinate values stored in memory usually do not occur simultaneously, it is common for a momentary size difference to exist between the camera image and the corresponding display window. The momentary size difference causes corruption of the camera image displayed in the display window. The corruption often manifests as a visual effect, e.g., glitch, in the displayed camera image.

One prior art approach for avoiding corruption of the camera image while changing the coordinate values that define the camera image and the display window sizes involves disabling a camera interface through which the camera image is received. More specifically, the camera interface is disabled while the required coordinate values are changed and made effective, then the camera interface is re-enabled to continue receiving camera images. While avoiding the momentary corruption of the displayed camera image, this prior art approach results in a loss of camera image data during the period in which the camera interface is disabled.

In view of the foregoing, a solution is needed for maintaining consistency between an incoming camera image size and a corresponding display window size while avoiding both corruption of the displayed camera image and loss of camera image data.

### SUMMARY OF THE INVENTION

The present invention provides a method and associated apparatus for displaying a live image in a display window without corruption or loss of image data. More specifically, the method and associated apparatus of the present invention maintains consistency between a size of an image to be displayed and a size of a display window in which the image is to be displayed. The method requires implementation of dimension value changes associated with the image to be displayed and the display window, to be delayed until all required dimension value changes have been stored in a memory. Upon completion of storing each required dimension value change in the memory, a size change completion signal is provided by setting an enable bit within the memory. Upon receipt of a trigger signal while the enable bit is set, the dimension value changes associated with the image to be displayed and the display window are implemented together. Thus, the present invention provides a solution for changing the display window size while maintaining continuous consistency between the sizes of the image to be displayed and display window. Furthermore, visual corruption of the displayed image and loss of image data are avoided.

In one embodiment, a method for displaying an image in an electronic medium is disclosed. The method includes changing a first set of dimension values associated with an image being displayed. The image being displayed remains undisturbed when changing the first set of dimension values. The method also includes changing a second set of dimension values associated with a display region in which the image is being displayed. The display region remains undisturbed when changing the second set of dimension values. A completion signal is provided to indicate completion of changing the first set of dimension values and the second set of dimension values. Also, a trigger signal is received to indicate a beginning of a new image to be displayed. The method further includes implementing the changed first set of dimension values and the changed second set of dimension values upon receiving the trigger signal while the completion signal is being provided.

In another embodiment, a method for displaying a live camera image in a picture-in-picture (PIP) window is disclosed. The method includes an operation for receiving an input to change a size of the PIP window. In response to receiving the input, operations are performed to change a value stored in a PIP window dimension register and a value stored in a camera image dimension register. The method also includes an operation for setting an enable bit to indicate a completion of changing the values stored in the PIP window dimension register and the camera image dimension register. The method further includes receiving a new frame signal associated with the camera image, and implementing the values stored in the PIP window dimension register and the camera image dimension registers upon receiving the new frame signal depending on the enable bit setting. The enable bit being set to indicate completion of changing the values stored in the PIP window dimension register and the camera image dimension register enables implementation of the values stored in the PIP window dimension register and the camera image dimension register upon receiving the new frame signal.

In another embodiment, a method for implementing dimension register updates corresponding to a displayed camera image and associated display region is disclosed. The method includes receiving a signal indicating a beginning of a new camera image frame. The method also includes examining enable bits associated with dimension registers that define a size of the displayed camera image and a size of a display region in which the camera image is displayed. The enable bits provide a status indication of dimension register change completion. The method further includes implementing the values stored in the dimension registers when any enable bit indicates a completed status.

In another embodiment, a display controller for use in an electronic device having an image display capability is disclosed. The display controller includes a first set of dimension registers configured to store dimension values for resizing an image to be displayed. Each of the first set of dimension registers includes an enable bit. The display controller also includes a second set of dimension registers configured to store dimension values for defining a portion of a display memory in which to store the image to be displayed. Each of the second set of dimension registers includes an enable bit. The display controller further includes image synchronization circuitry configured to recognize an asserted enable bit setting in any dimension register of the first set of dimension registers and the second set of dimension registers. The image synchronization circuitry is further configured to implement dimension values stored in each of the first set of dimension registers and the second set of dimension registers upon both recognizing the asserted enable bit setting and receiving a trigger signal indicating a beginning of a new image to be displayed.

Other aspects of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a block diagram of a display controller, in accordance with one embodiment of the present invention;

FIG. 2 is an illustration depicting an exemplary sequence of operations performed by the display controller of FIG. 1, in accordance with one embodiment of the present invention;

FIG. 3 is an illustration showing a method for changing dimension register values in a display controller, in accordance with one embodiment of the present invention; and

FIG. 4 is an illustration showing a method for implementing changes that have been made to dimension registers within a display controller being operated to display a live camera image in a PIP window, in accordance with one embodiment of the present invention.

### DETAILED DESCRIPTION

The present invention provides a method and associated apparatus for displaying a live image in a display window without corruption or loss of image data. More specifically, the method and associated apparatus of the present invention maintains consistency between a size of an image to be displayed and a size of a display window in which the image is to be displayed. The method requires implementation of dimension value changes associated with the image to be displayed and the display window, to be delayed until all required dimension value changes have been stored in a memory. Upon completion of storing each required dimension value change in the memory, a size change completion signal is provided by setting an enable bit within the memory. Upon receipt of a trigger signal while the enable bit is set, the dimension value changes associated with the image to be displayed and the display window are implemented together. Thus, the present invention provides a solution for changing the display window size while maintaining continuous consistency between the sizes of the image to be displayed and display window. Furthermore, visual corruption of the displayed image and loss of image data are avoided.

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

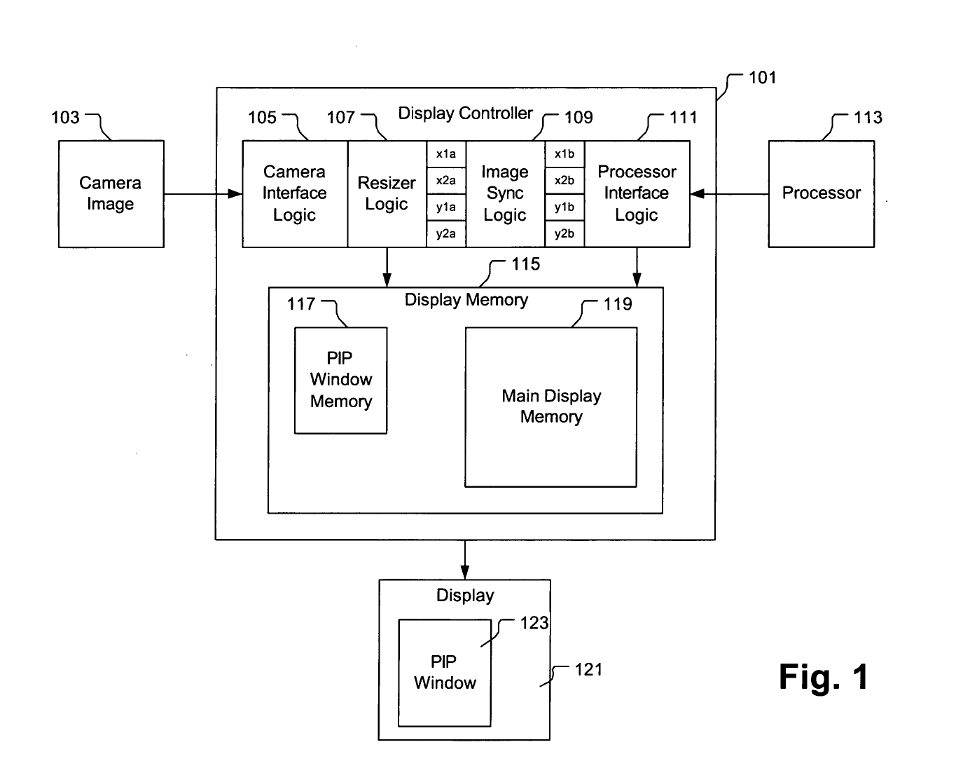

FIG. 1 is an illustration showing a block diagram of a display controller 101, in accordance with one embodiment of the present invention. The display controller 101 includes camera interface logic 105 configured to receive data defining a camera image 103. In one embodiment, the data defining the camera image 103 is supplied by a digital video camera. It should be appreciated, however, that the data defining the camera image 103 can originate from any electronic device capable of capturing or converting an image to a digital data format. The camera interface logic 105 is further configured to communicate with resizer logic 107. The resizer logic 107 functions to change a size of the camera image 103 received by the camera interface logic 105. For example, the resizer logic 107 can be used to crop, expand, or scale the camera image 103.

In one embodiment, the camera image 103 is received and processed in a rectangular format. In this embodiment, the resizer logic 107 is capable of accessing four registers (x1a, x2a, y1a, and y2a) used to store values defining an extent of the resized camera image. For discussion purposes, the four registers x1a, x2a, y1a, and y2a are referred to as camera image dimension registers. The x1a and x2a camera image dimension registers contain values defining the minimum and maximum extent, respectively, of the resized camera image in the x dimension, i.e., the horizontal dimension. The y1a and y2a camera image dimension registers contain values defining the minimum and maximum extent, respectively, of the resized camera image in the y dimension, i.e., the vertical dimension.

The display controller 101 also includes processor interface logic 111 for communicating with a processor 113 of a host device. Through the processor interface logic 111, the processor 113 can communicate instructions to the display controller 101. For example, the processor 113 can communicate to the display controller 101 a size of a display region in which the received camera image 103 should be displayed. Considering the embodiment in which the camera image 103 is received and processed in the rectangular format, the processor 113 is capable of writing to four registers (x1b, x2b, y1b, and y2b) used to store values defining an extent of the display region in which the resized camera image is to be displayed. In one embodiment, the display region represents a picture-in-picture (PIP) window 123 to be displayed over a portion of a main display region 121. For discussion purposes, the display region in which the camera image is to be displayed is referred to as a PIP window 123. Correspondingly, the four registers x1b, x2b, y1b, and y2b are referred to as PIP window dimension registers. The x1b and x2b PIP window dimension registers contain values defining the minimum and maximum extent, respectively, of the PIP window in the x dimension, i.e., the horizontal dimension. The y1b and y2b PIP window dimension registers contain values defining the minimum and maximum extent, respectively, of the PIP window in the y dimension, i.e., the vertical dimension.

Though the previously described embodiment uses four dimension registers to define each of the camera image to be displayed and the corresponding display region, it is contemplated that a different number of dimension registers can be used in alternative embodiments. For example, if the camera image to be displayed and the corresponding display region are each of non-rectangular shape, a different number of dimension registers may be sufficient/required to fully define the non-rectangular shape. In another example, the camera image to be displayed and the corresponding display region can have a rectangular shape in which one or more corners of the rectangular shape remain fixed. In this example, either one or two dimension registers will be required to define the extent of the rectangular shape, i.e., horizontal extent and/or vertical extent. For discussion purposes, however, the present invention is described in terms of using a rectangular region to define the camera image to be displayed and the corresponding display region, wherein the rectangular region can be varied in size and position.

The display controller 101 also includes a display memory 115 defined to include both a PIP window memory portion 117 and a main display window memory portion 119. In one embodiment, main display image data used to populate the main display memory portion 119 is communicated to the display controller 101 from the host processor 113 through the processor interface logic 111. Also, the PIP window memory portion 117 is populated by data representing the resized version of the received camera image 103, as communicated from the resizer logic 107. The final displayed image is rendered based on the data stored in the main display memory portion 119 and the PIP window memory portion 117. It should be appreciated, that the PIP window 123 is essentially displayed over a corresponding area of the main display 121.

In order for the camera image 103 to be displayed properly in the PIP window 123, the size of the resized camera image, as provided by the resizer logic 107, must correspond to the size of the PIP window 123 in which the resized camera image is to be displayed. For example, if a quarter VGA camera image (320×240) is received by the camera interface logic 105 and the PIP window size is 100×100, the resizer logic 107 needs to resize the 320×240 camera image to match the 100×100 PIP window size. The resizer logic 107 can be controlled to perform the necessary resizing operation by either cropping, expanding, or scaling the received camera image 103. In the present example, the camera dimension registers and the PIP window dimension registers each store values defining a 100×100 resized camera image and a 100×100 PIP window.

The display controller 101 further includes image synchronization (sync) logic 109 defined to ensure that dimensional consistency is continuously maintained between the resized camera image to be displayed and the PIP window. More specifically, the image sync logic 109 ensures consistency between the camera image dimension registers and the PIP window dimension registers (collectively referred to as dimension registers) prior to implementation of the dimension values stored therein. Thus, values stored in the dimension registers can be changed without automatic implementation of the changed values. When the image sync logic 109 has determined that all of the dimension registers have been appropriately changed, the image sync logic 109 directs the values stored in the dimension registers to be implemented in an essentially simultaneous manner. Therefore, the image sync logic 109 ensures that the values stored in the camera image dimension registers correspond to the values stored in the respective PIP window dimension registers when implemented, thereby avoiding any corruption of the displayed image.

In order to recognize when the dimension registers have been appropriately changed, the image sync logic 109 is defined to monitor an enable bit present within each of the camera image dimension registers and the PIP window dimension registers. The enable bit is set in the final register to be changed upon completion of its value change. In one embodiment, the enable bit of each dimension register is maintained in a high state. Therefore, setting of the enable bit is defined as storing a low state in the enable bit of the final register to be changed upon completion of its value change. In another embodiment, the enable bit of each dimension register is maintained in a low state. Therefore, setting of the enable bit is defined as storing a high state in the enable bit of the final register to be changed upon completion of its value change. It should be appreciated that the final register to be changed can be identified based on the dimension registers that have been changed and the dimension registers initially required to be changed.

Once an enable bit of any dimension register has been set, the image sync logic 109 recognizes that the values stored in each of the camera image dimension registers and the PIP window dimension registers are ready for implementation. At this point, the image sync logic 109 is defined to recognize a trigger signal serving to initiate implementation of the values currently stored in the dimension registers. In one embodiment, the trigger signal is associated with the camera image data being received through the camera interface logic 105. For example, a vertical synchronization (VSYNC) signal representing a new image frame can be used as the trigger signal. It should be appreciated, however, that the image sync logic 109 can be defined to recognize other signals as representing the trigger signal. Once the trigger signal is recognized while the enable bit is set, the image sync logic 109 functions to simultaneously implement the current values stored in each of the camera dimension registers and the image dimension registers. Thus, in the example where the VSYNC signal represents the trigger signal, changes to the camera image size and the PIP window size are implemented between camera image frames.

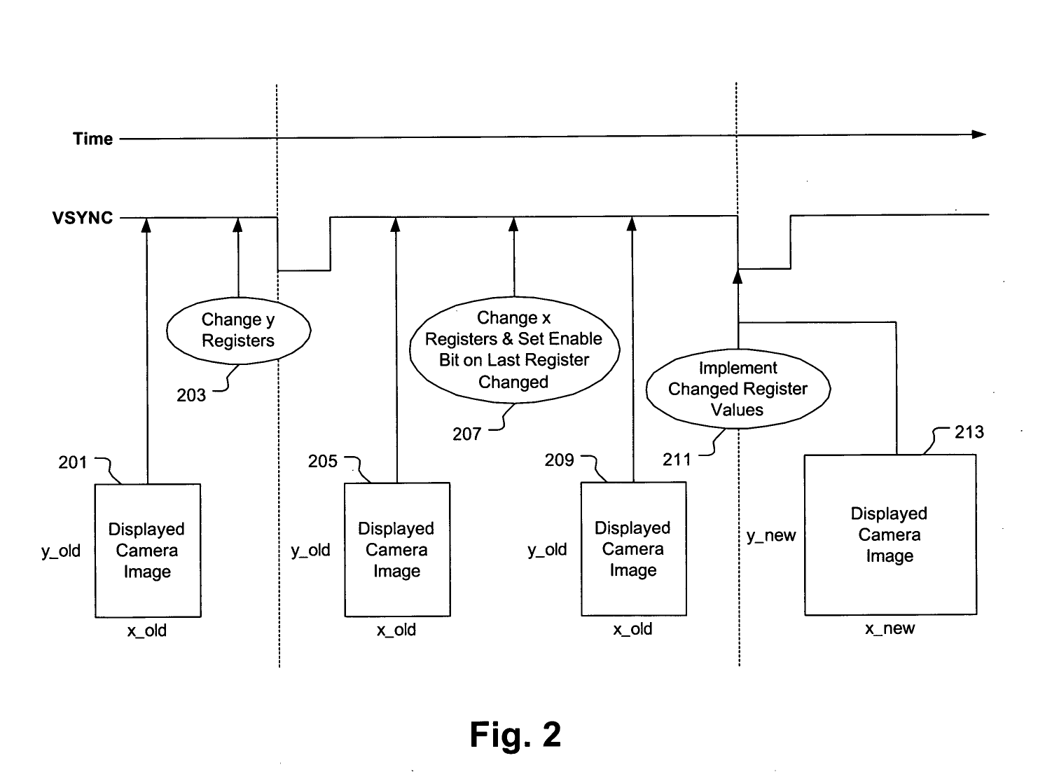

FIG. 2 is an illustration depicting an exemplary sequence of operations performed by the display controller 101 of FIG. 1, in accordance with one embodiment of the present invention. The operations of FIG. 2 are shown with respect to time, as indicated by a “Time” arrow. A VSYNC signal serves as the trigger signal for initiating implementation of the values currently stored in the dimension registers. The VSYNC signal is also shown with respect to time. Beginning the sequence of operations, an appropriately resized camera image is displayed in a PIP window 201, wherein the x dimension values are represented together as x_old and the y dimension values are represented together as y_old. Thus, values representing the x_old and y_old dimensions have been stored in both the camera dimension registers and the PIP window dimension register and previously implemented.

In a following operation 203, the y dimension registers are changed from y_old to y_new to comply with an instruction received from the host processor. Changing the y dimension registers can include changing the minimum and/or maximum y dimension values in both the camera image dimension registers and the PIP window dimension registers. In one embodiment, a dimension register duplication mode is activated to cause the required y dimension value changes to be duplicated across both the camera image dimension registers and PIP window dimension registers. In other words, one write operation is performed to store a common value in corresponding camera image dimension registers and PIP window dimension registers that are required to store the same value. In another embodiment, a separate write operation is used to store a required value in each camera image dimension register and each PIP window dimension register.

It should be understood, that changes to the y dimension registers as described with respect to the operation 203 are not automatically implemented. As previously discussed, in order for the current values stored in the dimension registers to be implemented, at least one enable bit defined within each of the dimension registers must be set when the trigger signal is received. Thus, following the operation 203, the camera image continues to be displayed in the PIP window 205 based on the x_old and y_old dimension values because at least one enable bit had not been set when the trigger signal, i.e., the VSYNC signal, was received.

In a following operation 207, the x dimension registers are changed from x_old to x_new to comply with an instruction received from the host processor. Changing the x dimension registers can include changing the minimum and/or maximum x dimension values in both the camera image dimension registers and the PIP window dimension registers. In one embodiment, the dimension register duplication mode is activated to cause the required x dimension value changes to be duplicated across both the camera image dimension registers and PIP window dimension registers, in a manner similar to the y dimension register duplication mode previously discussed. Thus, one write operation is performed to store a common value in corresponding camera image dimension registers and PIP window dimension registers that are required to store the same value. In another embodiment, a separate write operation is used to store a required value in each camera image dimension register and each PIP window dimension register.

The operation 207 also includes setting the enable bit in the last dimension register to be changed upon completion of changing the value stored therein. It should be appreciated, that when operating in dimension register duplication mode, the enable bit can be set in either one or both of the last pair of dimension registers to be simultaneously written. Setting at least one enable bit does not cause the dimension register changes to be immediately implemented. However, setting at least one enable bit does enable implementation of the dimension register changes upon receipt of a following trigger signal. Thus, following the operation 207, the camera image continues to be displayed in the PIP window 209 based on the x_old and y_old dimension values because a necessary trigger signal has not been received while the enable bit is set.

In the operation 211, the trigger signal is received and the current dimension register values are implemented in an essentially simultaneous manner. Since the current dimension register values represent the changed values y_new and x_new from operations 203 and 207, respectively, the camera image and the PIP window 213 are displayed based on the x_new and y_new dimension values. In the present example, the VSYNC signal represents a new frame of camera image data. Thus, in the present example, implementation of changes to the PIP window size are implemented between camera image frames.

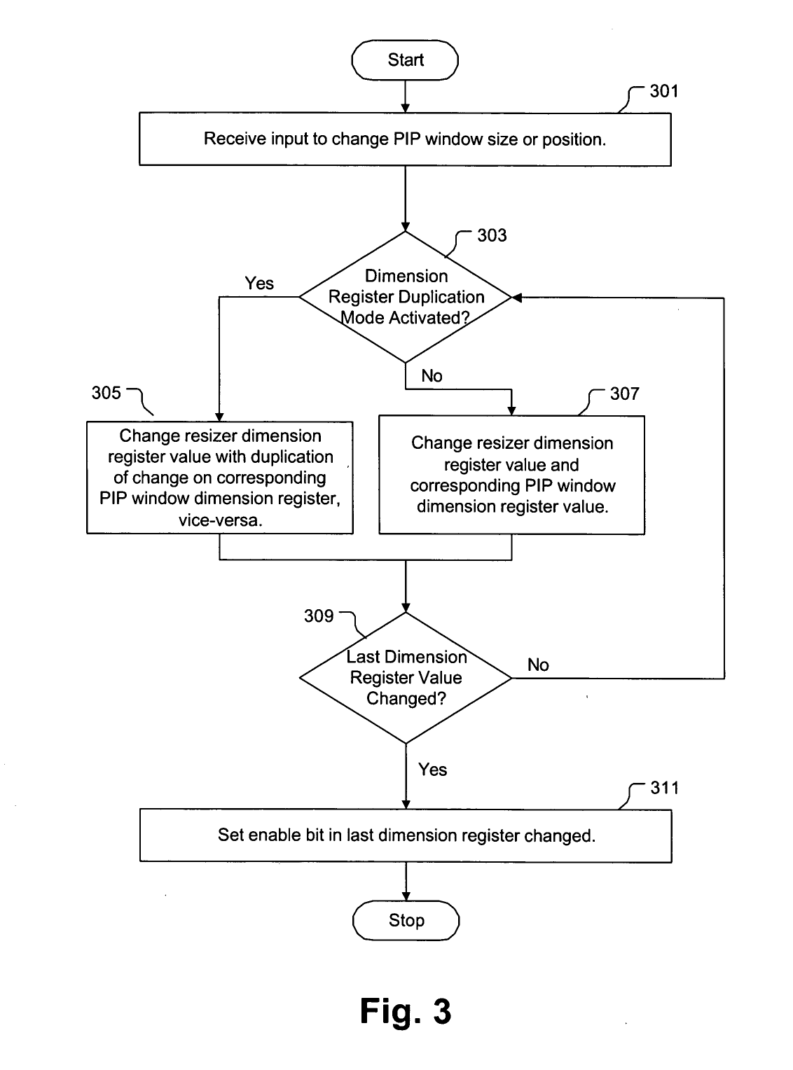

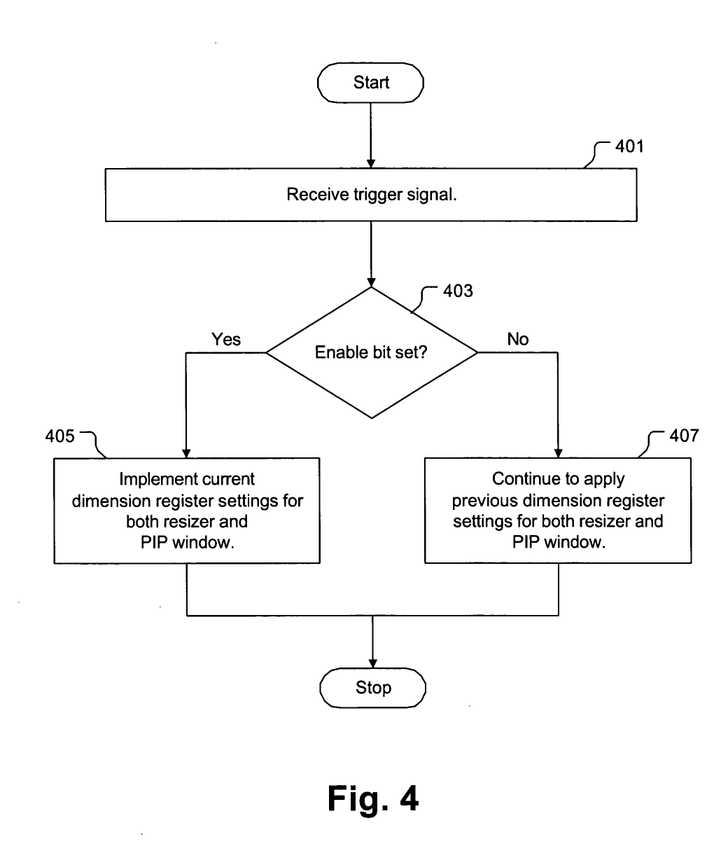

It should be appreciated that the display controller 101 as described with respect to FIGS. 1 and 2 operates to implement changes to the resized camera image and PIP window sizes without requiring the camera interface to be disabled, thus avoiding loss of incoming camera image data. Also, since the display controller 101 operates to implement size changes to the resized camera image and PIP window in an essentially simultaneous manner according a properly selected trigger signal, manifestation of visual artifacts in the displayed image is avoided. FIGS. 3 and 4, as described below, further illustrate methods for operating the display controller 101 of FIGS. 1 and 2.

FIG. 3 is an illustration showing a method for changing dimension register values in a display controller, in accordance with one embodiment of the present invention. In an operation 301, an input is received to change the PIP window size. In one embodiment, the input can be received through an interface provided by a host device in which the display controller resides. For example, in various embodiments the host device is a portable electronic device such as a cellular phone, a personal digital assistant, a web tablet, or a pocket personal computer, among others. In either of these exemplary embodiments, the host device can provide a number of input mechanisms for resizing or repositioning the PIP window. Examples of such input mechanisms include keys, buttons, touch screen capability, voice recognition capability, etc.

The method continues with an operation 303 for determining whether a dimension register duplication mode is activated. If the dimension register duplication mode is activated, the method proceeds with an operation 305 in which one or more resizer dimension register values are changed according to the PIP window size change specified in the received input. Changes to the resizer dimension registers are duplicated within the corresponding PIP window dimension registers. For example, if four resizer dimension registers and four PIP window dimension registers are required to be changed, the dimension register duplication mode of operation 305 enables all dimension register changes to be made in four rather than eight write operations. Also, it should be understood that the operation 305 can be performed from the perspective of changing the PIP window dimension registers and duplicating the changes within the corresponding resizer dimension registers.

If it is determined in the operation 303 that the dimension register duplication mode is not activated, the method proceeds to an operation 307. In the operation 307, values are changed within various resizer dimension registers and PIP window dimension registers according to the PIP window size change specified in the received input. In the operation 307, each dimension register change is performed by a separate write operation.

Upon completion of either the operation 305 or the operation 307, the method proceeds with an operation 309. In the operation 309, a determination is made as to whether the last dimension register value has been changed as required to comply with the received input. If the last dimension register value has not been changed, the method continues with the necessary dimension register changes. However, if the last dimension register has been changed, the method proceeds to an operation 311 for setting an enable bit in the last dimension register changed. Upon completion of the operation 311, all dimension register changes required to implement the PIP window size change have been made in the various dimension registers of the display controller, and the enable bit has been set to indicate such. Therefore, following completion of operation 311 and upon receipt of a trigger signal, the changed dimension register values will be implemented.

FIG. 4 is an illustration showing a method for implementing changes that have been made to dimension registers within a display controller being operated to display a live camera image in a PIP window, in accordance with one embodiment of the present invention. The method includes an operation 401 for receiving a trigger signal in the display controller. In one embodiment, the trigger signal is defined as a VSYNC signal indicating a start of a new camera frame. In an operation 403, a determination is made as to whether at least one enable bit within any dimension register has been set. If at least one enable bit has been set, the method proceeds with an operation 405. In the operation 405, current values, i.e., changed values, stored in the various resizer dimension registers and PIP widow dimension registers are implemented in an essentially simultaneous manner. If at least one enable bit has not been set, the method proceeds with an operation 407 in which the display controller continues to apply previously implemented dimension register values for both the resizer and the PIP window.

One skilled in the art will appreciate that the display controller of the present invention can be defined on a semiconductor chip using logic gates configured to provide the functionality of the methods previously discussed. For example, a hardware description language (HDL) can be employed to synthesize hardware and a layout of the logic gates for providing the necessary functionality described herein.

With the above embodiments in mind, it should be understood that the present invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

1. A method for displaying an image in an electronic medium, comprising:
changing a first set of dimension values associated with an image being displayed, wherein the image being displayed remains undisturbed when changing the first set of dimension values;
changing a second set of dimension values associated with a display region in which the image is being displayed, wherein the display region remains undisturbed when changing the second set of dimension values;
providing a completion signal indicating completion of changing the first set of dimension values and the second set of dimension values;
receiving a trigger signal indicating a beginning of a new image to be displayed; and
implementing the changed first set of dimension values and the changed second set of dimension values upon receiving the trigger signal while the completion signal is being provided.

2. A method for displaying an image in an electronic medium as recited in claim 1, wherein changing the first set of dimension values and the second set of dimension values spans a number of trigger signal receptions while the completion signal has not yet been provided.

3. A method for displaying an image in an electronic medium as recited in claim 1, further comprising:
operating image synchronization logic to recognize receipt of the trigger signal while the completion signal is being provided; and
operating the image synchronization logic to cause an essentially simultaneous implementation of the changed first set of dimension values and the changed second set of dimension values.

4. A method for displaying an image in an electronic medium as recited in claim 1, wherein the first set of dimension values are stored in four registers associated with camera image resizer logic and the second set of dimension values are stored in four registers associated with a picture-in-picture (PIP) window.

5. A method for displaying an image in an electronic medium as recited in claim 4, wherein providing the completion signal is performed by setting an enable bit within a last register changed, wherein the last register changed represents a final register required to have its dimension value changed.

6. A method for displaying an image in an electronic medium as recited in claim 4, wherein changing the first set of dimension values stored in the four registers associated with camera image resizer logic is performed by duplicating changes made to the second set of dimension values stored in the four registers associated with the PIP window.

7. A method for displaying an image in an electronic medium as recited in claim 1, wherein the image is a camera image and the trigger signal is a VSYNC signal indicating a new frame of the camera image.

8. A method for displaying a live camera image in a picture-in-picture (PIP) window, comprising:
receiving an input to change a size of the PIP window;
changing a value stored in a PIP window dimension register;
changing a value stored in a camera image dimension register;
setting an enable bit to indicate a completion of changing the values stored in the PIP window dimension register and the camera image dimension register;
receiving a new frame signal associated with the camera image; and
implementing the values stored in the PIP window dimension register and the camera image dimension register upon receiving the new frame signal, wherein implementing the values is enabled by the enable bit being set to indicate a completion of changing the values stored in the PIP window dimension register and the camera image dimension register.

9. A method for displaying a live camera image in a PIP window as recited in claim 8, further comprising:
delaying implementation of the changed values stored in the PIP window dimension register and the camera image dimension register until the new frame signal is received while the enable bit is set to indicate a completion of changing the values.

10. A method for displaying a live camera image in a PIP window as recited in claim 8, wherein changing the values stored in the PIP window dimension register and the camera image dimension register spans a number of new frame signals while the enable bit has not yet been set.

11. A method for displaying a live camera image in a PIP window as recited in claim 8, wherein the new frame signal associated with the camera image is a VSYNC signal.

12. A method for displaying a live camera image in a PIP window as recited in claim 8, wherein each PIP window dimension register and each camera image dimension register includes the enable bit, the enable bit being set in a last dimension register to be changed upon completion of the change in the last dimension register.

13. A method for implementing dimension register updates corresponding to a displayed camera image and associated display region, comprising:
receiving a signal indicating a beginning of a new camera image frame;
examining enable bits associated with dimension registers defining a size of the displayed camera image and a size of a display region in which the camera image is displayed, wherein the enable bits provide a status indication of dimension register change completion; and
implementing values stored in the dimension registers when any enable bit indicates a completed status.

14. A method for implementing dimension register updates corresponding to a displayed camera image and associated display region as recited in claim 13, further comprising:
maintaining implementation of previous values stored in the dimension registers when receiving the signal indicating the beginning of the new camera image frame when each enable bit indicates an incomplete status of the dimension register changes.

15. A display controller for use in an electronic device having an image display capability, comprising:
a first set of dimension registers configured to store dimension values for resizing an image to be displayed, each of the first set of dimension registers including an enable bit;
a second set of dimension registers configured to store dimension values for defining a display region in which the image to be displayed, each of the second set of dimension registers including an enable bit; and
image synchronization circuitry configured to recognize an asserted enable bit setting in any dimension register of the first set of dimension registers and the second set of dimension registers, the image synchronization circuitry being further configured to implement dimension values stored in each of the first set of dimension registers and the second set of dimension registers upon both recognizing the asserted enable bit setting and receiving a trigger signal indicating a beginning of a new image to be displayed.

16. A display controller for use in an electronic device having an image display capability as recited in claim 15, wherein the image synchronization circuitry is configured to recognize a vertical synchronization signal as the trigger signal, the vertical synchronization signal to be provided in conjunction with image data to be received by the display controller.

17. A display controller for use in an electronic device having an image display capability as recited in claim 15, wherein the image synchronization circuitry is configured to implement the dimension values stored in each of the first set of dimension registers and the second set of dimension registers in a simultaneous manner.

18. A display controller for use in an electronic device having an image display capability as recited in claim 15, further comprising:
camera interface circuitry configured to receive data defining the image to be displayed; and
resizer circuitry configured to adjust a size of the image to be displayed in accordance with dimension values stored in the first set of dimension registers, the resizer circuitry further configured to be controlled by the image synchronization circuitry.

19. A display controller for use in an electronic device having an image display capability as recited in claim 15, wherein the display controller is incorporated into a portable electronic computing device.

20. A display controller for use in an electronic device having an image display capability as recited in claim 19, wherein the portable electronic computing device is selected from the group consisting of a cellular phone, a personal digital assistant, a web tablet, and a pocket personal computer.
